(19) United States
(12) Patent Application Publication
(10) Pub. No.: US 2012/0238200 A1
(43) Pub. Date: Sep. 20, 2012

(54) VENT CAP KIT AND METHOD OF INSTALLATION

(75) Inventor: Avi Avraham Berkovitz, Brampton (CA)

(73) Assignee: Dundas Jafine Inc.

(21) Appl. No.: 13/051,603

(22) Filed: Mar. 18, 2011

(51) Int. Cl. F24F 13/20; B23P 19/04; B23P 6/00

(52) U.S. Cl. 454/367; 29/402.03; 29/402.08

(57) ABSTRACT

A method of installing a replacement vent cap involves removing existing louvers from an existing vent cap and fitting a first gasket around a periphery of the existing vent cap. A second gasket is fitted to a collar of a replacement vent cap and the replacement vent cap is placed over the existing vent cap so that a back face of the second gasket lies against a front face of the first gasket. The replacement vent cap is then secured over the existing vent cap. A vent cap kit that may be used with the method has a first gasket and a second gasket. The first gasket has a central opening bounded, by a plurality of removable nested annular bands. The second gasket has a central opening sized to receive the collar of a replacement vent cap and can have an outer periphery co-extensive with an outer periphery of said first gasket. The kit can also include a replacement vent cap with a plurality of through holes for receiving fasteners and a central opening bounded by a collar.

### BACKGROUND

This invention relates to a vent cap kit and to a method for installing a vent cap.

A building may have a wall-mounted exhaust vent for a dryer or a fan. The vent cap for the exhaust vent is typically exposed to the outdoor environment and degrades over time. Replacement of the vent cap may be a significant undertaking where the cap is solidly fixed into the wall or to the conduit which the vent cap terminates. This invention seeks to address this problem.

### SUMMARY

In one aspect, a method of installing a replacement vent cap involves removing existing louvers from an existing vent cap and fitting a first gasket around a periphery of the existing vent cap. A second gasket is fitted to a collar of a replacement vent cap and the replacement vent cap is placed over the existing vent cap so that a back face of the second gasket lies against a front face of the first gasket. The replacement vent cap is then secured over the existing vent cap.

In other aspect, a vent cap kit is provided. The kit has a first gasket, a second gasket, and a vent cap. The first gasket has a central opening bounded by a plurality of removable nested annular bands. The second gasket has a central opening. The vent cap has a plurality of through holes for receiving fasteners, and a central opening bounded by a collar. The central opening of the second gasket is sized to receive the collar of the vent cap.

In a further aspect, a vent cap kit is provided having a first gasket and a second gasket. The first gasket has a central opening bounded by a plurality of removable nested annular bands. The second gasket has a central opening, a plurality of through holes for receiving fasteners, and an outer periphery co-extensive with an outer periphery of the first gasket.

Other features and advantages will become apparent from the following description in conjunction with the drawings.

### DRAWINGS

In the figures which illustrate an example embodiment of the invention,

FIG. 1 is an exploded view of a vent cap kit made in accordance with this invention,

FIG. 2 is a side view of an assembled portion of the vent cap kit of FIG. 1,

FIG. 3 is a front view of an aged installed vent cap,

FIG. 4 is a front view of the cap of FIG. 3 with the louvers removed and the rearward gasket of the vent cap kit of FIG. 1 installed,

FIG. 5 is a rear perspective view of an assembled portion of the vent cap kit of FIG. 1,

FIG. 6 is a front perspective view of the vent cap kit of FIG. 1 partially installed on the aged cap of FIG. 4,

FIG. 7 is a front perspective view of the vent cap kit of FIG. 1 installed on the aged cap of FIG. 4, and

FIG. 8 is a front perspective view of an alternate vent cap for use in the vent cap kit.

### DETAILED DESCRIPTION

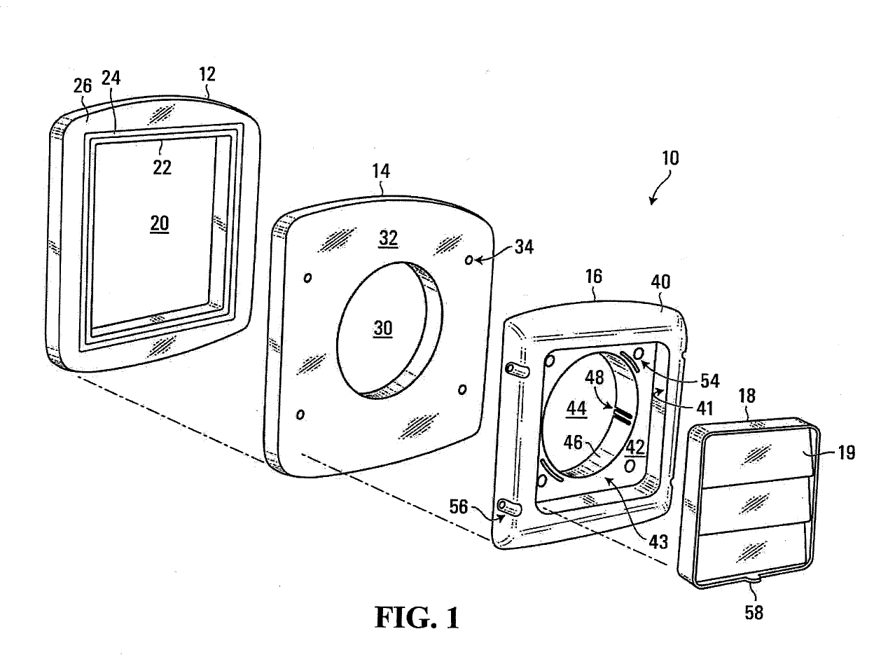

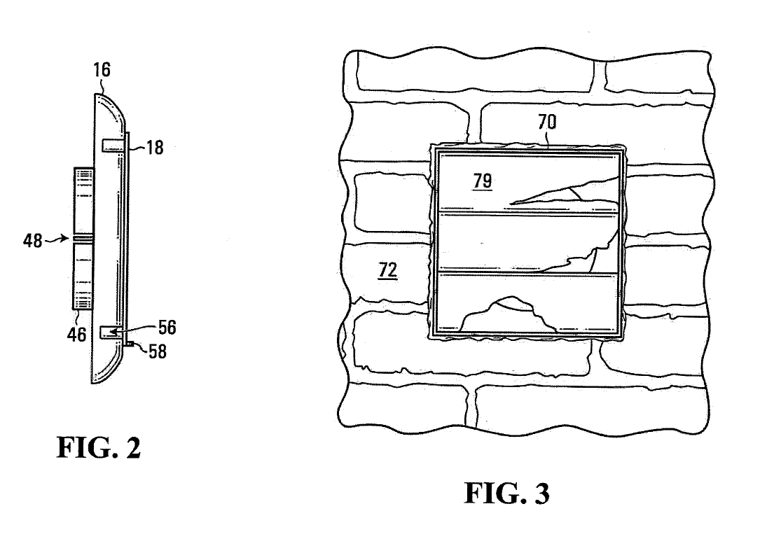

Turning to FIGS. 1 and 2, a vent cap kit 10 has a rearward gasket 12, a forward gasket 14, a vent cap 16, and louver frame 18 with louvers 19. The rearward and forward gaskets are made of a compliant material such as foam plastic. The rearward gasket has a square central opening 20 bounded by an inner square band 22 that is removably joined to an outer square band 24. The outer square band 24 is, in turn, removably joined to the main body 26 of the rearward gasket 12. These nested square bands may be formed by die cutting the rearward gasket in order to partially cut out these bands so that the remaining points of attachment can be broken. The forward gasket 14 has circular central opening 30 bounded by the main body 32 of the gasket. There are four small through holes 34 spaced about main body 32 of the forward gasket 14.

The vent cap 16 may be fabricated of a hard plastic material. With reference to FIGS. 1 and 2, the cap has an outer shell 40 with a central inward step 41 to a land 42 so as to define a square-shaped central recess 43. The inner extent of the land, is defined by a circular central opening 44 that opens into a rearwardly projecting annular collar 46. The collar 46 has axially directed slots 48 which extend from the rearward end of the collar.

There are four small through holes 54 which are spaced about land 42 and four small through holes 56 which are spaced about the periphery of the outer shell 40.

The louvers 19 are pivotably mounted to the louver frame 18. The louver frame has a forwardly projecting pull-tab 58 along its lower edge.

Turning to FIG. 3, an existing vent cap 70 may be mounted to a side wall 72 of a building. As shown, the existing vent cap is flush mounted so as to be incorporated into the wall. Depending upon the manner of construction of the wall, stucco or mortar may be used to incorporate the vent cap 70 into the wall. Vent cap 70 is shown to have aged with visible breaks in the louvers 79 of the cap.

Vent cap kit 10 (FIG. 1) may be used to provide a new wall vent, as follows.

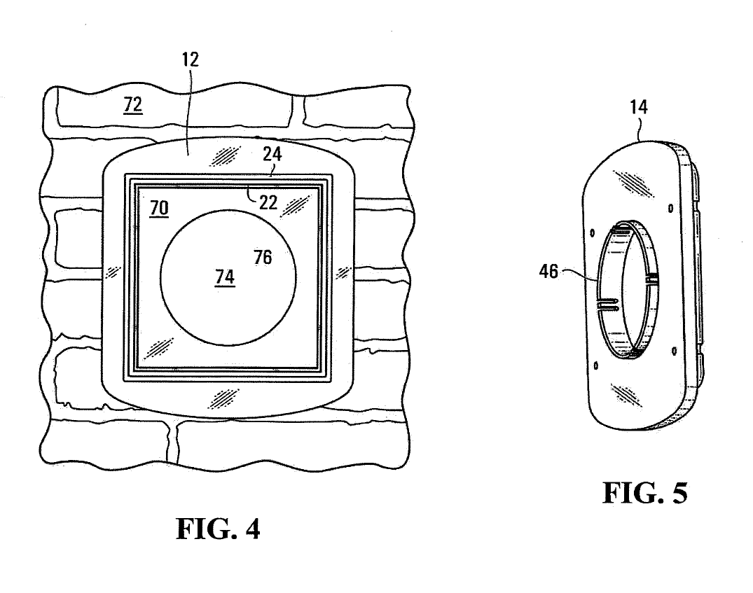

First, each of the louvers 79 of the existing vent cap 70 is removed. As seen in FIG. 4, this uncovers the opening 74 of the vent collar 76. Next, rearward gasket 12 of the vent cap kit is fitted .around the periphery of the existing vent cap 70. Rearward gasket 12 is shown in FIG. 4 as having both of inner square band 22 and outer square band 24 in place. For larger existing vent caps, one or both of inner square band 22 and outer square band 24 may need to be removed from the rearward gasket to re-size the central opening 20 of the rearward gasket so that the gasket can be properly fitted to a given larger existing vent cap.

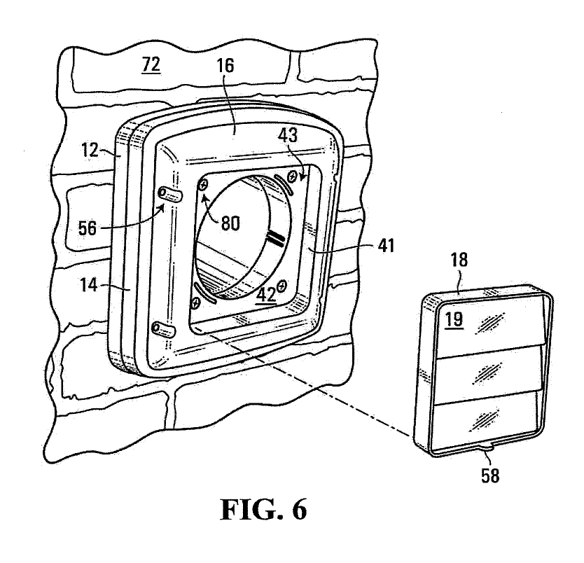

Next, as shown in FIG. 5, forward gasket 14 is fitted around the collar 46 of the replacement vent cap 40. The vent cap 40 with gasket 14 is then pushed onto the existing vent cap 70 so that a back face of gasket 14 lies against a front face of gasket 12 and such that the collar 46 of the replacement vent cap is received within collar 76 of the existing vent cap. The outside diameter of the collar 46 can be designed to match the inside diameter of a standard sized vent collar of an existing vent cap. However, the collar 76 may be somewhat malformed. Axially directed slots 48 in collar 46 accommodate manufacturing tolerances and, malformations in the collar 76 of the existing vent cap as the slots provide some radial compliance to collar 46 so that the collar 46 can be forced into the collar 76 if the outside diameter of the collar 46 is, at any radial point, slightly larger than the inside diameter of the existing vent collar 76.

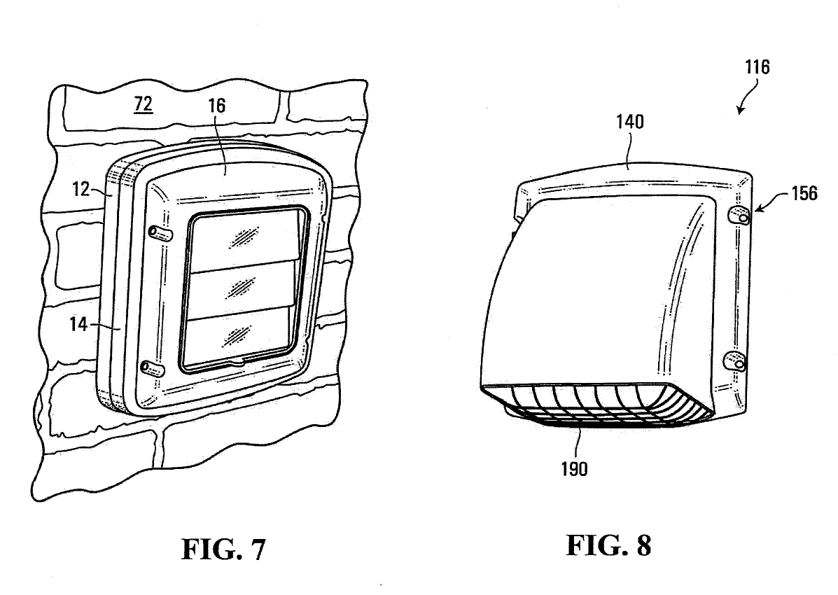

With reference to FIG. 6, once in place on the existing vent, screws 80 (or other suitable fasteners) may be inserted into small through holes 54 (FIG. 1) in land 42 and screwed into the existing vent cap to hold the replacement vent cap 16 in place and to compress the gaskets 12, 14 between the replacement vent cap 16 and the wall 72. The gaskets 12 and 14 therefore provide a seal between the replacement vent cap 16 and the wall 72. To maximize the area of the seal, as seen in FIG. 6, the outer periphery of gasket 12 is co-extensive with the outer periphery of gasket 14. Lastly, louver frame 18 may be press fit into the central recess 43 of cap 16 as shown in FIGS. 6 and 7 so that the louver frame is frictionally held in place.

If the replacement vent cap 16 or either gasket 12, 14 was damaged, a user may pull tab 58 of louver frame 18 to withdraw the louver frame from step 41. This exposes screws 80 which may be removed so that the vent cap 16 and gaskets 12 and 14 can be removed and replaced, as required.

If the screws 80 cannot obtain a sufficient purchase in existing vent cap 70, screws may instead be inserted through small holes 56 in the replacement vent cap 16 and small through holes 34 (FIG. 1) in forward gasket 14—which holes 34 align with holes 54 when gasket 14 is carried on collar 46—and screwed into either or both of the existing vent cap and the wall 72.

It may be that an existing vent cap 70 sits proud from wall 72 rather than being incorporated in the wall but is still not readily removable because of its attachment to the venting conduit which it terminates. Vent cap kit 10 is also advantageously used in such circumstances.

While the vent cap kit 10 has been described with vent cap 16 having removable louver frame 18, the kit may also employ a different type of vent cap. For example, turning to FIG. 8, vent cap 116 could be used with the kit. Cap 116 has an outer shell 140 with four small through holes 156 spaced about the periphery of the outer shell. The outer shell 140 extends over the front of the cap leaving a bottom opening across which a cage 190 extends. With cap 116, the outer shell 140 is integrally formed with the remainder of the cap. Therefore, the only screw holes available to affix the cap to an existing vent cap 70 (FIG. 3) is screws holes 156. Therefore, to affix cap 116, screws are inserted through screw holes 156 and aligned holes 34 (FIG. 1) in forward gasket 14 (FIG. 1) in order to screw these screws into the wall and/or the existing vent cap. Therefore, it will be apparent that the two gaskets of the kit may be used with any suitable vent cap.

Other modifications will be apparent to those skilled in the art and, therefore, the invention is defined in the claims.

What is claimed is:

1. A method of installing a replacement vent cap, comprising:
removing existing louvers from an existing vent cap;
fitting a first gasket around a periphery of said existing vent cap;
fitting a second gasket to a collar of a replacement vent cap;
placing said replacement vent cap over said existing vent cap so that a back face of said second gasket lies against a front face of said first gasket; and
securing said replacement vent cap over said existing vent cap.

2. The method of claim 1 wherein said replacement vent cap has a plurality of removable louvers and a plurality of fastener holes behind said removable louvers and wherein said securing comprises:
with said removable louvers removed, attaching fasteners to said existing vent cap through said fastener holes; and
installing said removable louvers.

3. The method of claim 2 wherein said removable louvers are pivotably mounted to a frame and wherein said installing said removable louvers comprises pressing said frame into a central recess of said replacement vent cap.

4. The method of claim 1 wherein said first gasket has a central opening bounded by a plurality of removable nested annular bands and wherein said fitting said first gasket comprises removing one or more of said nested annular bands to selectively size said central opening of said first gasket.

5. The method of claim 1 wherein said fitting said first gasket is such that a back face of said first gasket abuts a wall from which said existing vent cap protrudes.

6. The method of claim 5 wherein said first gasket and said second gasket form a seal between said replacement vent cap and said wall when said replacement vent cap is secured over said existing vent cap.

7. The method of claim 1 wherein said replacement vent cap has a peripheral flange with a plurality of fastener holes, wherein said second gasket has a plurality of fastener holes which, when said replacement vent cap is placed over said existing vent cap, align with said plurality of fastener holes of said peripheral flange of said replacement vent cap, and wherein said securing comprises attaching fasteners to said existing vent cap through said fastener holes of said flange of said replacement vent cap and said fastener holes of said second gasket.

8. The method of claim 1 wherein said replacement vent cap has a rearwardly projecting collar and wherein said placing said replacement vent cap over said existing vent cap comprises inserting said collar into a collar of said existing vent cap.

9. The method of claim 9 wherein said collar of said replacement vent cap has a plurality of axially directed slots extending from its rear edge and wherein said inserting comprises pressing said collar of said replacement vent cap into said collar of said existing vent cap with said slots providing radial compliance of said collar of said replacement vent cap.

10. A vent cap kit, comprising:
a first gasket having a central opening bounded by a plurality of removable nested annular bands;
a second gasket having a central opening;
a vent cap having:
a plurality of through holes for receiving fasteners; and
a central opening bounded by a collar;
wherein said central opening of said second gasket is sized to receive said collar of said vent cap.

11. The kit of claim 10 wherein said vent cap has a plurality of removable louvers and wherein said plurality of through holes are located behind said removable louvers for receiving fasteners.

12. The kit of claim 11 wherein said vent cap has a central recess and said removable louvers comprise a frame to which said removable louvers are pivotably mounted, said frame being frictionally held within said recess.

13. The kit of claim 12 wherein said frame has a forwardly projecting pull tab for facilitating removal of said removable louvers.

14. The kit of claim 10 wherein said collar has a plurality of axially directed slots extending from a rear edge thereof.

15. The kit of claim 10 wherein said second gasket has an outer periphery co-extensive with an outer periphery of said first gasket.

16. The kit of claim 10 wherein said vent cap has a peripheral flange with a plurality of through holes for receiving fasteners.

17. The kit of claim 16 wherein said second gasket has a plurality of through holes for receiving fasteners located so as to be aligned with said through holes of said flange when said second gasket receives said collar of said vent cap.

18. A vent cap kit, comprising:
a first gasket having a central opening bounded by a plurality of removable nested annular bands;
a second gasket having a central opening and a plurality of through holes for receiving fasteners;
wherein said second gasket has an outer periphery co-extensive with an outer periphery of said first gasket; and
wherein said central opening of said second gasket is sized to receive a collar of a vent cap.
